(19) United States
(12) Patent Application Publication
(10) Pub. No.: US 2019/0174941 A1
(43) Pub. Date: Jun. 13, 2019

(54) Silicon multifunctional anti-slip mat

(71) Applicant: Renhong CHEN, GuangDong (CN)

(72) Inventor: Renhong CHEN, GuangDong (CN)

(21) Appl. No.: 15/834,067

(22) Filed: Dec. 7, 2017

(51) Int. Cl. A47G 27/02; C09D 5/33; C09D 175/04; C09D 5/08; C09D 133/12

(52) U.S. Cl. CPC A47G 27/02; C09D 5/004; C09D 133/12; C09D 5/08; C09D 175/04

(57) ABSTRACT

The present invention discloses a silicon multifunctional anti-slip mat comprising an anti-slip body formed by a woven mesh fabric and organic silicon portions provided at two sides of the woven mesh fabric; fillings are provided between the woven mesh fabric and each of the organic silicon portions; an anti-UV coating layer and a transparent coating layer are provided from bottom to top above the anti-slip mat body; an anti-corrosive coating layer is provided at a bottom portion of the anti-slip mat body. By providing organic silicon portions at two sides of the woven mesh fabric, the anti-slip mat is adhesive and capable of securely adhere to the rug/floor surface; besides, organic silicon surface is not contaminable and thus would not contaminate the rug/floor surface, thus overcoming the rugs/floor surfaces contamination problems of common anti-slip mats. It is colorless, odorless, clean, sanitary and aesthetically pleasing.

### BACKGROUND OF THE INVENTION

The present invention relates to a silicon anti-slip mat and more particularly a silicon multifunctional anti-slip mat which is anti-UV, anti-corrosive, wear resistant, fire-proof, hydrophobic, oleophobic and colorful.

Anti-slip mats are commonly used in daily life and industries. Anti-slip mats function to prevent slipping, such as slipping of rugs. It is easy for rugs to move on polished floor surfaces, therefore it is very dangerous. Movement of a rug could be prevented by placing an anti-slip mat between the rug and the floor surface. However, while anti-lip mats made of common materials such as PVC are adhesive and anti-slip, but they are also contaminable and contaminate the floor surfaces and the rugs easily. Besides, existing anti-slip mats are mainly PVC mats and rubber anti-slip mats. PVC mats release odors such as ammonia and so forth, thereby affecting working and living environments. Rubber anti-slip mats easily causes allergy, and are easy to get dried and worn out; they are also easy to grow mould in humid environments.

### BRIEF SUMMARY OF THE INVENTION

An object of the present invention is to provide a silicon multifunctional anti-slip mat which is provided with organic silicon portions at two sides of the woven mesh fabric so that the anti-slip mat is adhesive and capable of securely adhere to the rug/floor surface; besides, organic silicon surface is not contaminable and thus would not contaminate the rug/floor surface and any other surface. It could serve as anti-slip mat for rugs, door mats, baby chairs, sheets and mattresses, articles, tools, fruits, cupboards, wardrobes and so forth, thus overcoming the rugs/floor surfaces contamination problems of common anti-slip mats. It is colorless and odorless, clean and sanitary.

To attain this, the present invention provides the following technical scheme:

A silicon multifunctional anti-slip mat comprising an anti-slip body formed by a woven mesh fabric and organic silicon portions provided at two sides of the woven mesh fabric; fillings are provided between the woven mesh fabric and each of the organic silicon portions; an anti-UV coating layer and a transparent coating layer are provided from bottom to top above the anti-slip mat body; a pulling handle is provide at each of two ends of a top portion of the transparent coating layer; an anti-corrosive coating layer is provided at a bottom portion of the anti-slip mat body.

As an improvement of the present invention, a bottom end of each of the pulling handles adheres to a surface of the transparent coating layer by means of a suction cup; a groove is provided at a top surface of the pulling handle.

As an improvement of the present invention, the woven mesh fabric has a thickness of 0.08 mm-10 mm.

As an improvement of the present invention, the woven mesh fabric has a mesh hole diameter of 0.1 mm-50 mm.

As an improvement of the present invention, the anti-slip mat body is manufactured as follows: S1: Slurry preparation: pour 100 parts of organic silicon, 3-100 parts of solvent, 10-80 parts of calcium carbonate fillings, 3-10 parts of inorganic fire retardant and 0.5-15 parts of additive into a mixing vessel for mixing with a high-speed mixer to obtain a slurry; S2: Immersion and calendaring: convey the prepared slurry by a slurry pump to a slurry tank which is provided with rotatable rollers therein; hang the woven mesh fabric on a mechanical rail for immersion in the slurry tank where the slurry is press-coated on the woven mesh fabric by calendaring and scraping when the woven mesh fabric passes through the rollers; S3: Scraping off slurry to form holes: scrap off excess slurry by a scraping blade to facilitate shaping and blow air from top to bottom using a fan to restore mesh fabric form in order to form even mesh holes; S4: Drying and rolling up: convey the silicon coated woven mesh fabric into a drying chamber which maintains a temperature of 80-200° C. for drying for a few minutes, then remove the woven mesh fabric from the drying chamber by pulling means and then roll up the woven mesh fabric; S5: Cutting into shape: cut the woven mesh fabric into different sizes of anti-slip mat body according to needs.

As an improvement of the present invention, the anti-UV coating layer is mainly formed by evenly mixing and coating a base comprising waste slag, clay and alta mud, a solvent comprising acetone, a binder comprising polyurethane, and additives comprising paint and surfactant, wherein the clay of the base has a mass fraction of 0.5%-30%, mass ratio of the waste slag to the alta mud is 0.1-1.2, mass ratio of the acetone to the base is 0.1-0.3, mass ratio of the polyurethane to the base is 0.2-0.6, mass ratio of the paint to the base is 0-0.1, mass ratio of the surfactant to the base is 0-0.05.

As an improvement of the present invention, the transparent coating layer is a transparent coating layer which is amphiphobic and abrasion resistant.

As an improvement of the present invention, the transparent coating layer which is amphiphobic and abrasion resistant is manufactured as follows: D1: add 10%-35% of ammonia water to a silicon dioxide aerogel with a particle size of 50-200 nm; mix for 0.2-0.5 h at a shear rate of 1200-2400 r/min, then adjust the shear rate to 120-600 r/min; under protection by nitrogen gas, evenly drip acrylic acid monomer dissolved with an initiator and a coupling agent into the reaction system, then increase temperature to 50-70° C. and react for 3-6 h to obtain a silicon dioxide aerogel modified with polyacrylic acid; D2: evenly mix perfluoroalkyl alcohol, p-toluenesulfonic acid and the silicon dioxide aerogel modified with polyacrylic acid, and increase temperature to 100-120° C. and react for 0.5-2 h to obtain a silicon dioxide aerogel modified with perfluoroalkylethyl polyacrylate; D3: evenly mix methyl methacrylate, the silicon dioxide aerogel modified with perfluoroalkylethyl polyacrylate, acrylonitrile butadiene styrene copolymers, acetoacetate-ethyl-methacrylate, p-toluenesulfonic acid and benzoyl peroxide, and coat on the surface of the anti-UV coating layer, and solidifies for 4-10 h.

Furthermore, mass ratio of the ammonia water to the silicon dioxide aerogel is 1-2:1; mass ratio of the acrylic acid monomer to the silicon dioxide aerogel is 10-20:1; the coupling agent is in an amount of 1-5% wt of the mass of the acrylic acid monomer; mass ratio of the perfluoroalkyl alcohol to the silicon dioxide aerogel modified with polyacrylic acid is 2-4:1; the p-toluenesulfonic acid is in an amount of 1-5% wt of the perfluoroalkyl alcohol; mass ratio of the methyl methacrylate to the silicon dioxide aerogel modified with perfluoroalkylethyl polyacrylate is 3-8:1; the acrylonitrile butadiene styrene copolymers is in an amount of 5-15 wt % of the methyl methacrylate; the acetoacetate-ethyl-methacrylate is in an amount of 5-10% wt of the methyl methacrylate; the p-toluenesulfonic acid is in an amount of 1-1.5% wt of the methyl methacrylate; the benzoyl peroxide is in an amount of 2-6% wt of the methyl methacrylate.

In comparison with the prior art, the present invention has the following advantageous effects:

By providing organic silicon portions at two sides of the woven mesh fabric, the anti-slip mat of the present invention is adhesive and capable of securely adhere to the rug/floor surface; besides, organic silicon surface is not contaminable and thus would not contaminate the rug/floor surface, thus overcoming the rugs/floor surfaces contamination problems of common anti-slip mats. It is colorless, odorless, clean and sanitary. By adding fire retardant to common organic silicon preparations, the fire retardance of the anti-slip mat could be significantly enhanced. By providing an anti-UV coating layer, an anti-corrosive coating layer and a transparent layer which is amphiphobic and abrasion resistant, the application scope of the anti-slip mat could be further expanded, thus increasing the usage life of the anti-slip mat. The anti-UV coating layer may be prepared into various colors according to needs, thus increasing the aesthetic level of the anti-slip mat. By providing pulling handles at a top portion of the transparent coating layer, it is easy to lift up the anti-slip mat when it is not in use.

### BRIEF DESCRIPTION OF THE DRAWINGS

FIG. 1 is a schematic view showing the structure of the present invention.

FIG. 2 is a schematic view showing the pulling handle of the present invention.

FIG. 3 is a line graph showing the impact of the mass ratio of the waste slag to the alta mud on UV-blocking rate when the mass fraction of the clay is 0.5%.

FIG. 4 is a line graph showing the impact of the mass ratio of the waste slag to the alta mud on UV-blocking rate when the mass fraction of the clay is 10%.

FIG. 5 is a line graph showing the impact of the mass ratio of the waste slag to the alta mud on UV-blocking rate when the mass fraction of the clay is 25%.

In the drawings, 1 denotes the anti-slip body; 2 denotes the woven mesh fabric; 3 denotes the organic silicon portions; 4 denotes the calcium carbonate fillings; 5 denotes the anti-UV coating layer; 6 denotes the transparent coating layer; 7 denotes the anti-corrosive coating layer; 8 denotes the pulling handle; 9 denotes the suction cup; 10 denotes the groove.

### DETAILED DESCRIPTION OF THE INVENTION

The present invention will be clearly and comprehensively described with an embodiment and the accompanying drawings. It is obvious that the embodiment described herein is only one of the embodiments of the present invention but not all embodiments of the present invention. All other embodiments made by a person skilled in the art without any inventive labor fall within the scope of the present invention.

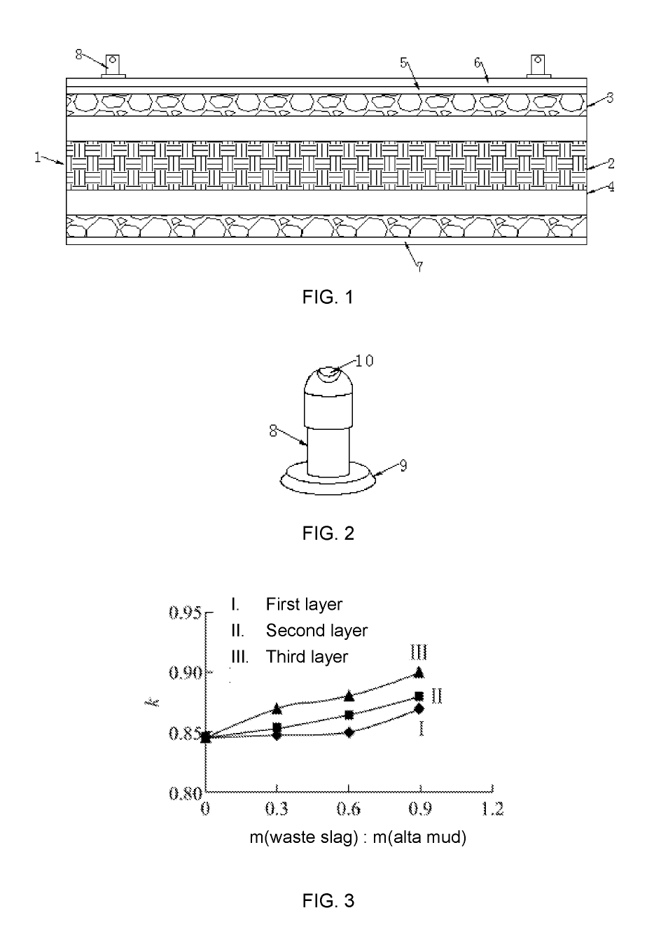

FIG. 1 illustrates a silicon multifunctional anti-slip mat of the present invention which comprises an anti-slip mat body 1 formed by a woven mesh fabric 2 and organic silicon portions 3 provided at two sides of the woven mesh fabric 2. Fillings 4 are provided between the woven mesh fabric 2 and each of the organic silicon portions 3. The fillings 4 are mainly calcium carbonate. An anti-UV coating layer 5 and a transparent coating layer 6 are provided from bottom to top above the anti-slip mat body 1. A pulling handle 8 is provided at each of two ends of a top portion of the transparent coating layer 6. An anti-corrosive coating layer 7 is provided at a bottom portion of the anti-slip mat body 1. A bottom end of each of the pulling handles 8 adheres to a surface of the transparent coating layer 6 by means of a suction cup 9. A groove 10 is provided at a top surface of the pulling handle 8.

Furthermore, the woven mesh fabric 2 has a thickness of 0.08 mm-10 mm.

Furthermore, the woven mesh fabric 2 has a mesh hole diameter of 0.1 mm-50 mm.

The manufacturing method of the silicon multifunctional anti-slip mat of the present invention is as follows:

S1: Slurry preparation: pour 100 parts of organic silicon, 3-100 parts of solvent, 10-80 parts of calcium carbonate fillings, 3-10 parts of inorganic fire retardant and 0.5-15 parts of additive into a mixing vessel for mixing with a high-speed mixer to obtain a slurry;

S2: Immersion and calendaring: convey the prepared slurry by a slurry pump to a slurry tank which is provided with rotatable rollers therein; hang the woven mesh fabric 2 on a mechanical rail for immersion in the slurry tank where the slurry is press-coated on the woven mesh fabric by calendaring and scraping when the woven mesh fabric passes through the rollers;

S3: Scraping off slurry to form holes: scrap off excess slurry by a scraping blade to facilitate shaping and blow air from top to bottom using a fan to restore mesh fabric form in order to form even mesh holes;

S4: Drying and rolling up: convey the silicon coated woven mesh fabric 2 into a drying chamber which maintains a temperature of 80-200° C. for drying for a few minutes, then remove the woven mesh fabric from the drying chamber by pulling means and then roll up the woven mesh fabric;

S5: Cutting into shape: cut the woven mesh fabric into different sizes of anti-slip mat body 1 according to needs;

S6: Function enhancement: the processed anti-slip mat body 1 is coated with an anti-UV coating layer 5 on a top surface thereof; a transparent coating layer 6 is thereafter coated thereon; a pulling handle 8 is adhered to a top surface of the transparent coating layer 6 via a suction cup 9; finally an anti-corrosive coating layer 7 is coated at a bottom portion of the anti-slip mat body.

The anti-UV coating layer 5 is mainly formed by coating of waste slag modified compound anti-UV compound coating. The compound coating for fabric is prepared by evenly mixing different percentages of waste slag, clay and alta mud as base, acetone as solvent, and polyurethane as binder; when the clay of the base in the compound coating has a mass fraction of 0.5%, 10%, 25% and 30%, the mass ratios of the waste slag to the alta mud are 0.1, 0.35, 0.8 and 1.2 respectively; the mass ratios of the polyurethane to the base are 0.2:1, 0.3:1, 0.6:1.

Samples are obtained by weighing on an electric scale. The ingredients are grinded into even fine powder (0.02-0.05 mm) and then added to a container for mixing with acetone and polyurethane. When the material color is uniform and a gel is formed, evenly coat on the fabric surface as a first layer, a second layer and a third layer (the first layer has a coating thickness of 19 mm; the second layer has a coating thickness of 25 mm; the third layer has a coating thickness of 30 mm) respectively.

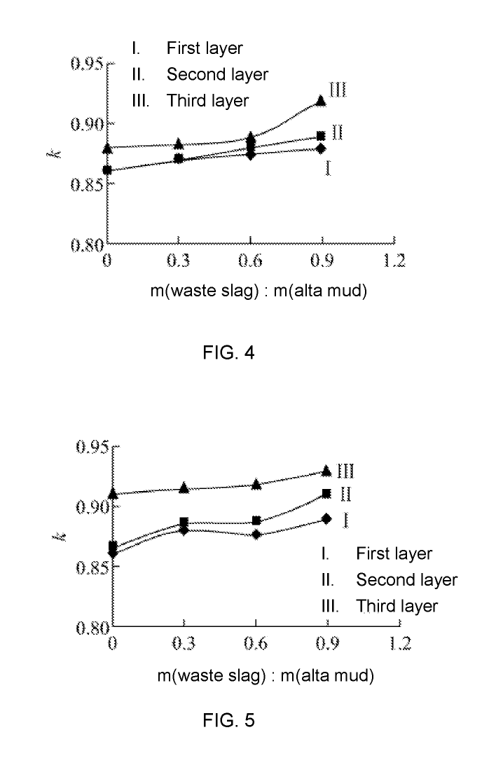

After drying, conduct testing using an UV testing apparatus. In FIGS. 3, 4 and 5, the impacts of the mass ratios of the waste slag to the alta mud on UV-blocking rate are shown, wherein the mass fractions of the clay are 0.5%, 10% and 25% respectively, and the mass ratio of the polyurethane to the base is 0.3:1. As shown in FIGS. 3, 4 and 5, with the increase in the mass fraction of the clay, the UV-blocking rate of the compound coating increases. When the mass fraction of the clay is fixed, with the increase in the mass ratio of the waste slag to the alta mud, the UV-blocking rate of the compound coating also increases. Furthermore, with the increase in the thickness of the coating, the UV-blocking rate of the compound coating also increases. When the mass fraction of the clay is 25%, and the mass ratio of the waste slag to the alta mud is 0.8, coating three layers of compound coating results in the highest UV-blocking rate. This shows that the waste slag in the base has a relatively high UV-blocking capability. When the mass ratio of the waste slag to the alta mud is 1.2:1, the anti-UV coating layer obtained is easy to dry and crack, and thus is not tested and shown in the drawings.

In the present invention, paint could be added to the anti-UV coating layer according to needs. For example, red iron oxide in an amount of 5% wt of the base may be added to the compound coating to obtain a red anti-UV coating layer; red iron oxide in an amount of 10% wt of the base may be added to the compound coating to obtain a dark red anti-UV coating layer; phthalocyanine blue in an amount of 10% wt of the base and high molecular compound surfactant in an amount of 5% wt of the base may be added to the compound coating to obtain a blue anti-UV coating layer.

The transparent coating layer 6 of the present invention may be conventional transparent coating layer for protecting the anti-UV coating layer 5, or a transparent coating layer which is amphiphobic and abrasion resistant.

The manufacturing method of the transparent coating layer which is amphiphobic and abrasion resistant is as follows:

D1: add 10%-35% of ammonia water to a silicon dioxide aerogel with a particle size of 50-200 nm; mix for 0.2-0.5 h at a shear rate of 1200-2400 r/min, then adjust the shear rate to 120-600 r/min; under protection by nitrogen gas, evenly drip acrylic acid monomer dissolved with an initiator and a coupling agent into the reaction system, then increase temperature to 50-70° C. and react for 3-6 h to obtain a silicon dioxide aerogel modified with polyacrylic acid;

D2: evenly mix perfluoroalkyl alcohol, p-toluenesulfonic acid and the silicon dioxide aerogel modified with polyacrylic acid, and increase temperature to 100-120° C. and react for 0.5-2 h to obtain a silicon dioxide aerogel modified with perfluoroalkylethyl polyacrylate;

D3: evenly mix methyl methacrylate, the silicon dioxide aerogel modified with perfluoroalkylethyl polyacrylate, acrylonitrile butadiene styrene copolymers, acetoacetate-ethyl-methacrylate, p-toluenesulfonic acid and benzoyl peroxide, and coat on the surface of the anti-UV coating layer, and solidifies for 4-10 h;

Wherein, the mass ratio of the ammonia water to the silicon dioxide aerogel is 1-2:1; the mass ratio of the acrylic acid monomer to the silicon dioxide aerogel is 10-20:1; the coupling agent is in an amount of 1-5% wt of the mass of the acrylic acid monomer; the mass ratio of the perfluoroalkyl alcohol to the silicon dioxide aerogel modified with polyacrylic acid is 2-4:1; the p-toluenesulfonic acid is in an amount of 1-5% wt of the perfluoroalkyl alcohol; the mass ratio of the methyl methacrylate to the silicon dioxide aerogel modified with perfluoroalkylethyl polyacrylate is 3-8:1; the acrylonitrile butadiene styrene copolymers is in an amount of 5-15 wt % of the methyl methacrylate; the acetoacetate-ethyl-methacrylate is in an amount of 5-10% wt of the methyl methacrylate; the p-toluenesulfonic acid is in an amount of 1-1.5% wt of the methyl methacrylate; the benzoyl peroxide is in an amount of 2-6% wt of the methyl methacrylate.

More specifically, evenly mix 2 mass parts of 10% wt of ammonia water and 1 mass part of silicon dioxide aerogel, then add 20 mass parts of acrylic acid monomer and 1 mass part of coupling agent to react for 6 h to obtain a silicon dioxide aerogel modified with polyacrylic acid; then mix 2 mass parts of perfluoroalkyl alcohol, 1 mass part of the silicon dioxide aerogel modified with polyacrylic acid and 0.02 mass part of p-toluenesulfonic acid and react for 2 h to obtain a silicon dioxide aerogel modified with perfluoroalkylethyl polyacrylate; finally, evenly mix 3 mass parts of methyl methacrylate, 1 mass part of the silicon dioxide aerogel modified with perfluoroalkylethyl polyacrylate, 0.15 mass part of acrylonitrile butadiene styrene copolymers, 0.15 mass part of acetoacetate-ethyl-methacrylate, 0.03 mass part of p-toluenesulfonic acid and 0.06 mass part of benzoyl peroxide and coat on the surface of the anti-UV coating layer, then solidify for 4 h in a drying room at 80° C. to obtain the transparent coating layer which is amphiphobic and abrasion resistant. The end product has a first grade adhesive level, good tensility, an impact strength of 24 J/m², a contact angle with the deionized water of 151-157°, a contact angle with peanut oil of 160-167°, and a rolling angle of <5°. When the thickness of the transparent coating layer which is amphiphobic and abrasion resistant is 20 mm, and one side of the transparent coating layer which is amphiphobic and abrasion resistant is put into a fire, the anti-slip mat does not show any changes in 60 s.

More particularly, evenly mix 1 mass part of 30% wt of ammonia water and 1 mass part of silicon dioxide aerogel, then add 10 mass parts of acrylic acid monomer and 0.1 mass part of coupling agent to react for 3 h to obtain a silicon dioxide aerogel modified with polyacrylic acid; then mix 4 mass parts of perfluoroalkyl alcohol, 1 mass part of the silicon dioxide aerogel modified with polyacrylic acid and 0.2 mass part of p-toluenesulfonic acid and react for 0.5 h to obtain a silicon dioxide aerogel modified with perfluoroalkylethyl polyacrylate; finally, evenly mix 8 mass parts of methyl methacrylate, 1 mass part of the silicon dioxide aerogel modified with perfluoroalkylethyl polyacrylate, 1.2 mass parts of acrylonitrile butadiene styrene copolymers, 0.8 mass part of acetoacetate-ethyl-methacrylate, 0.12 mass part of p-toluenesulfonic acid and 0.48 mass part of benzoyl peroxide and coat on the surface of the anti-UV coating layer, then solidify for 10 h in a drying room at 80° C. to obtain the transparent coating layer which is amphiphobic and abrasion resistant. The end product has a first grade adhesive level, good tensility, an impact strength of 21 KJ/m², a contact angle with the deionized water of 148-155°, a contact angle with peanut oil of 151-157°, and a rolling angle of <5°. When the thickness of the transparent coating layer which is amphiphobic and abrasion resistant is 20 mm, and one side of the transparent coating layer which is amphiphobic and abrasion resistant is put into a fire, the anti-slip mat does not show any changes in 60 s.

Although the embodiments of the present invention have been illustrated and described above, to the person skilled in the art, various changes, modifications, substitutions and variations not departing from the principle and spirit of the present invention may be made to the embodiments. The present invention is defined by the accompanying claims and equivalents thereof.

What is claimed is:

1. A silicon multifunctional anti-slip mat comprising an anti-slip body (1) formed by a woven mesh fabric (2) and organic silicon portions (3) provided at two sides of the woven mesh fabric (2); fillings are provided between the woven mesh fabric (2) and each of the organic silicon portions (3); characterized in that: an anti-UV coating layer (5) and a transparent coating layer (6) are provided from bottom to top above the anti-slip mat body (1); a pulling handle (8) is provide at each of two ends of a top portion of the transparent coating layer (6); an anti-corrosive coating layer (7) is provided at a bottom portion of the anti-slip mat body (1).

2. The silicon multifunctional anti-slip mat as in claim 1, characterized in that: a bottom end of each of the pulling handles (8) adheres to a surface of the transparent coating layer (6) by means of a suction cup (9); a groove (10) is provided at a top surface of the pulling handle (8).

3. The silicon multifunctional anti-slip mat as in claim 1, characterized in that: the woven mesh fabric (2) has a thickness of 0.08 mm-10 mm.

4. The silicon multifunctional anti-slip mat as in claim 1, characterized in that: the woven mesh fabric (2) has a mesh hole diameter of 0.1 mm-50 mm.

5. The silicon multifunctional anti-slip mat as in claim 1, characterized in that: the anti-slip mat body (1) is manufactured as follows:
S1: Slurry preparation: pour 100 parts of organic silicon, 3-100 parts of solvent, 10-80 parts of calcium carbonate fillings, 3-10 parts of inorganic fire retardant and 0.5-15 parts of additive into a mixing vessel for mixing with a high-speed mixer to obtain a slurry;
S2: Immersion and calendaring: convey the prepared slurry by a slurry pump to a slurry tank which is provided with rotatable rollers therein; hang the woven mesh fabric (2) on a mechanical rail for immersion in the slurry tank where the slurry is press-coated on the woven mesh fabric by calendaring and scraping when the woven mesh fabric passes through the rollers;
S3: Scraping off slurry to form holes: scrap off excess slurry by a scraping blade to facilitate shaping and blow air from top to bottom using a fan to restore mesh fabric form in order to form even mesh holes;
S4: Drying and rolling up: convey the silicon coated woven mesh fabric (2) into a drying chamber which maintains a temperature of 80-200° C. for drying for a few minutes, then remove the woven mesh fabric from the drying chamber by pulling means and then roll up the woven mesh fabric;
S5: Cutting into shape: cut the woven mesh fabric into different sizes of anti-slip mat body (1) according to needs.

6. The silicon multifunctional anti-slip mat as in claim 1, characterized in that: the anti-UV coating layer (5) is mainly formed by evenly mixing and coating a base comprising waste slag, clay and alta mud, a solvent comprising acetone, a binder comprising polyurethane, and additives comprising paint and surfactant, wherein the clay of the base has a mass fraction of 0.5%-30%, mass ratio of the waste slag to the alta mud is 0.1-1.2, mass ratio of the acetone to the base is 0.1-0.3, mass ratio of the polyurethane to the base is 0.2-0.6, mass ratio of the paint to the base is 0-0.1, mass ratio of the surfactant to the base is 0-0.05.

7. The silicon multifunctional anti-slip mat as in claim 1, characterized in that: the transparent coating layer (6) is a transparent coating layer which is amphiphobic and abrasion resistant.

8. The silicon multifunctional anti-slip mat as in claim 7, characterized in that: the transparent coating layer which is amphiphobic and abrasion resistant is manufactured as follows:
D1: add 10%-35% of ammonia water to a silicon dioxide aerogel with a particle size of 50-200 nm; mix for 0.2-0.5 h at a shear rate of 1200-2400 r/min, then adjust the shear rate to 120-600 r/min; under protection by nitrogen gas, evenly drip acrylic acid monomer dissolved with an initiator and a coupling agent into the reaction system, then increase temperature to 50-70° C. and react for 3-6 h to obtain a silicon dioxide aerogel modified with polyacrylic acid;
D2: evenly mix perfluoroalkyl alcohol, p-toluenesulfonic acid and the silicon dioxide aerogel modified with polyacrylic acid, and increase temperature to 100-120° C. and react for 0.5-2 h to obtain a silicon dioxide aerogel modified with perfluoroalkylethyl polyacrylate;
D3: evenly mix methyl methacrylate, the silicon dioxide aerogel modified with perfluoroalkylethyl polyacrylate, acrylonitrile butadiene styrene copolymers, acetoacetate-ethyl-methacrylate, p-toluenesulfonic acid and benzoyl peroxide, and coat on the surface of the anti-UV coating layer (5), and solidifies for 4-10 h.

9. The silicon multifunctional anti-slip mat as in claim 8, characterized in that: mass ratio of the ammonia water to the silicon dioxide aerogel is 1-2:1; mass ratio of the acrylic acid monomer to the silicon dioxide aerogel is 10-20:1; the coupling agent is in an amount of 1-5% wt of the mass of the acrylic acid monomer; mass ratio of the perfluoroalkyl alcohol to the silicon dioxide aerogel modified with polyacrylic acid is 2-4:1; the p-toluenesulfonic acid is in an amount of 1-5% wt of the perfluoroalkyl alcohol; mass ratio of the methyl methacrylate to the silicon dioxide aerogel modified with perfluoroalkylethyl polyacrylate is 3-8:1; the acrylonitrile butadiene styrene copolymers is in an amount of 5-15 wt % of the methyl methacrylate; the acetoacetate-ethyl-methacrylate is in an amount of 5-10% wt of the methyl methacrylate; the p-toluenesulfonic acid is in an amount of 1-1.5% wt of the methyl methacrylate; the benzoyl peroxide is in an amount of 2-6% wt of the methyl methacrylate.
